(19) United States
(12) Patent Application Publication
(10) Pub. No.: US 2013/0180252 A1
(43) Pub. Date: Jul. 18, 2013

(54) COMBUSTOR ASSEMBLY WITH IMPINGEMENT SLEEVE HOLES AND TURBULATORS

(71) Applicant: Wei Chen, Greenville, SC (US)

(72) Inventor: Wei Chen, Greenville, SC (US)

(73) Assignee: GENERAL ELECTRIC COMPANY, Schenectady, NY (US)

(21) Appl. No.: 13/353,071

(22) Filed: Jan. 18, 2012

(51) Int. Cl. F23R 3/16; B23P 15/00

(52) U.S. Cl. 60/754; 29/888.012

(57) ABSTRACT

A combustor assembly for use with a gas turbine. The combustor assembly may include a liner, an impingement sleeve disposed about the liner, and an airflow channel defined between the liner and the impingement sleeve. One or more holes may be disposed through the impingement sleeve, and one or more tubulators may be disposed within the airflow channel.

### FIELD OF THE DISCLOSURE

Embodiments of the present application relate generally to gas turbine engines and more particularly to combustor assemblies including impingement sleeve holes and turbulators.

### BACKGROUND OF THE DISCLOSURE

Generally described, a gas turbine engine may include a compressor for compressing an incoming flow of air, a combustor for mixing the compressed air with a flow of fuel and igniting the mixture, and a turbine to drive the compressor and an external load such as an electrical generator and the like. In order to cool the combustor, an impingement sleeve may be used to direct cooling air to hot regions thereon. The impingement sleeve may generally include holes so as to direct the cooling air where needed.

The use of the holes in the impingement sleeve may create a boundary layer of generally laminar cooling air along the combustor. Moreover, portions of the combustor nearest to the holes may include increased levels of heat transfer. This may cause non-uniformity of cooling of the combustor. There is therefore a desire to provide improved uniformity of heat transfer along the combustor.

### SUMMARY OF THE DISCLOSURE

Some or all of the above needs and/or problems may be addressed by certain embodiments of the present application. According to one embodiment, there is disclosed a combustor assembly for use with a gas turbine engine. The combustor assembly may include a liner, an impingement sleeve disposed about the liner, and an airflow channel defined between the liner and the impingement sleeve. One or more holes may be disposed through the impingement sleeve, and one or more turbulators may be disposed within the airflow channel.

According to another embodiment, there is disclosed a transition piece in a combustor assembly. The transition piece may include a liner, an impingement sleeve disposed about the liner to form the transition piece, and an airflow channel defined between the liner and the impingement sleeve. One or more holes may be disposed through the impingement sleeve, and one or more tubulators may be disposed within the airflow channel.

Further, according to another embodiment, there is disclosed a method for increasing heat transfer within a transition piece of a combustor assembly. The method may include forming an airflow channel between a liner and an impingement sleeve. The method may also include directing a flow of compressed air through the airflow channel via one or more holes in the impingement sleeve. Moreover, the method may include disrupting the flow of compressed air through the airflow channel with one or more turbulators disposed within the airflow channel.

Other embodiments, aspects, and features of the invention will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale, and wherein:

FIG. 1 is a schematic view of a gas turbine engine.

FIG. 2 is a side cross-sectional view of a combustor with an impingement sleeve.

FIG. 3 is a side cross-sectional view of an impingement hole.

FIG. 4 is a side cross-sectional view of an impingement hole and turbulator, according to an embodiment.

FIG. 5 is a top view of an impingement hole and turbulator, according to an embodiment.

FIG. 6 is a flow diagram illustrating details of an example method for increasing heat transfer within a transition piece of a combustor assembly, according to an embodiment.

### DETAILED DESCRIPTION OF THE DISCLOSURE

Illustrative embodiments will now be described more fully hereinafter with reference to the accompanying drawings, in which some, but not all embodiments are shown. The present application may be embodied in many different forms and should not be construed as limited to the embodiments set forth herein. Like numbers refer to like elements throughout.

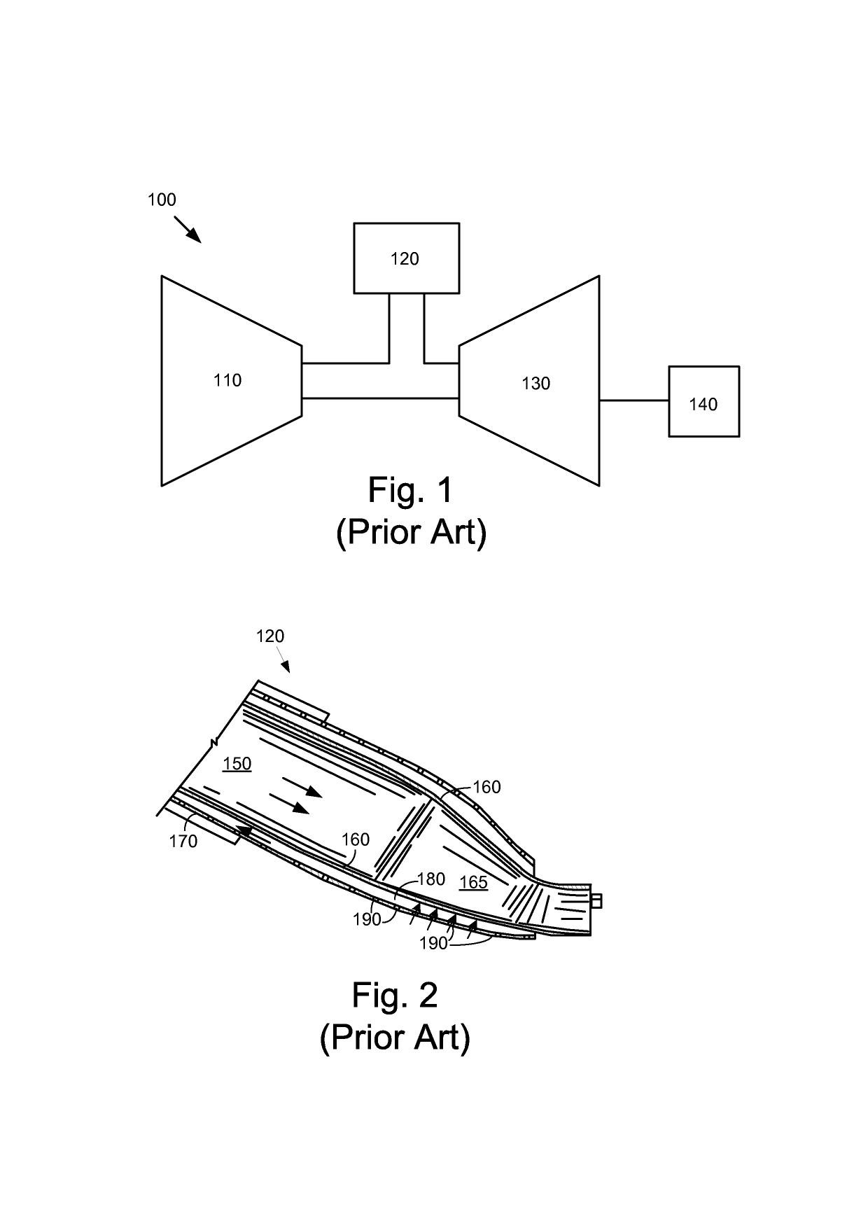

Referring now to the drawings in which like numbers refer to like elements throughout the several views, FIG. 1 shows a schematic view of a gas turbine engine 100. As described above, the gas turbine engine 100 may include a compressor 110 to compress an incoming flow of air. The compressor 110 delivers the compressed flow of air to a combustor 120. The combustor 120 mixes the compressed flow of air with a flow of fuel and ignites the mixture. The hot combustion gases are in turn delivered to a turbine 130 so as to drive the compressor 110 and an external load 140 such as an electrical generator and the like. The gas turbine engine 100 may use other configurations and components herein.

FIG. 2 shows a further view of the combustor 120. In this example, the combustor 120 may be a reverse flow combustor. Any number of different combustor 120 configurations, however, may be used herein. For example, the combustor 120 may include forward mounted fuel injectors, multi-tube aft fed injectors, single tube aft fed injectors, wall fed injectors, staged wall injectors, and other configurations that may be used herein.

As described above, high pressure air may exit the compressor 110, pass along the outside of a combustion chamber 150, and reverse direction as the air enters the combustion chamber 150 where the fuel/air mixture is ignited. Other flow configurations may be used herein. The combusted hot gases provide high radiative and convective heat loading along the combustion chamber 150 and a transition piece 165 before the gases enter the turbine 130. Accordingly, cooling of the combustion chamber 150 and the transition piece 165 may be required given the high temperature gas flow.

The combustion chamber 150 and the transition piece 165 may include a liner 160 so as to provide a cooling flow. The liner 160 may be positioned within an impingement sleeve 170 so as to create an airflow channel 180 therebetween. At least a portion of the air flow from the compressor 110 may pass through the impingement sleeve 170 and into the airflow channel 180. The air may be directed over the liner 160 for cooling the liner 160 before entry into the combustion chamber 140 or otherwise.

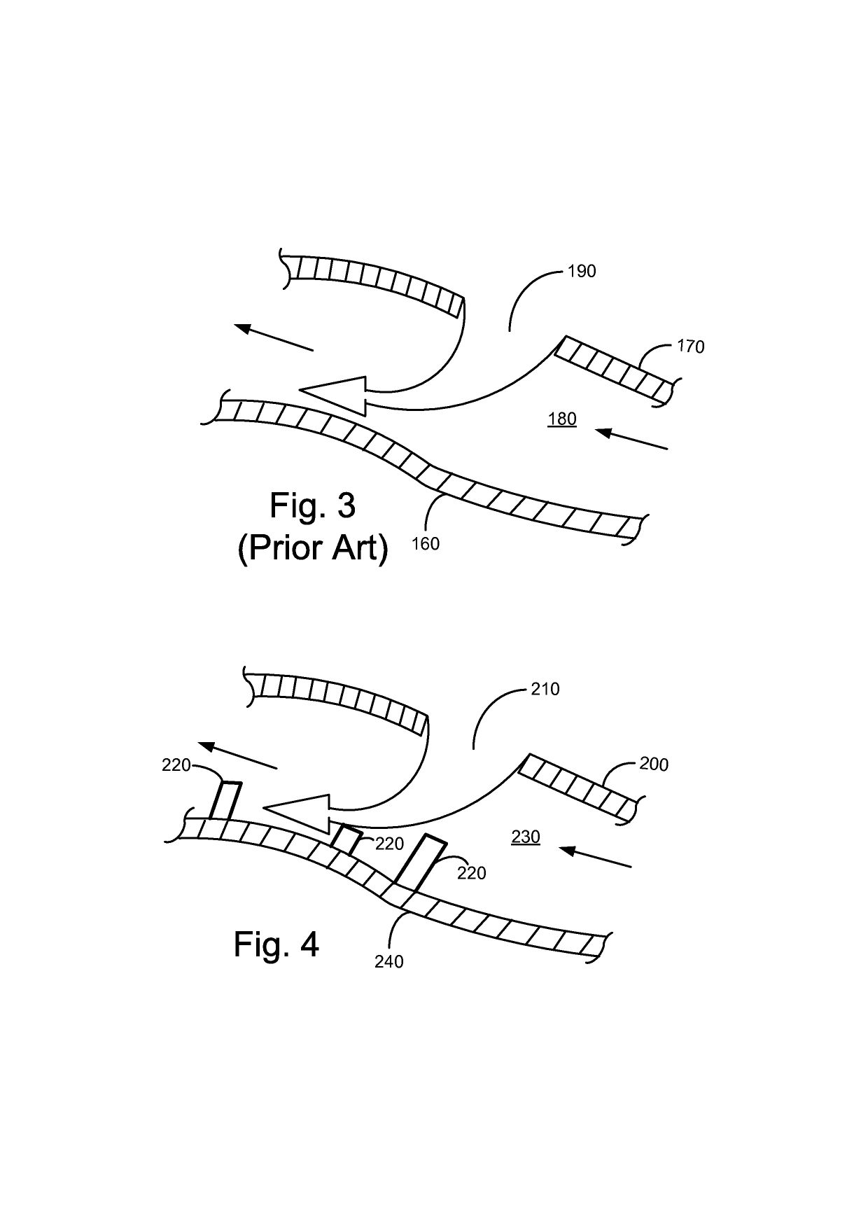

FIG. 3 shows an impingement sleeve 170 with a hole 190 positioned therein. As described above, at least a portion of the air flow from the compressor 110 may pass through the impingement sleeve 170 and into the airflow channel 180. The air may be directed over the liner 160 for cooling the liner 160 before entry into the combustion chamber 150 or otherwise.

The use of only the holes 190 to direct at least a portion of the air flow from the compressor 110 into the airflow channel 180 to cool the combustion chamber 150 and transition piece 165 may not provide adequate cooling. For example, a boundary layer may form along the liner 160 and impingement sleeve 170 of the airflow channel 180. The boundary layer may decrease the heat transfer between the combustion chamber 150 and/or the transition piece 165 and the cooling airflow within the airflow channel 180. Moreover, portions of the liner 160 nearest to the holes 190 may include increased levels of heat transfer, while portions of the liner 160 further away from the holes 190 may include decreased levels of heat transfer due to the boundary layer. This may cause non-uniformity of cooling of the combustion chamber 150 and the transition piece 165.

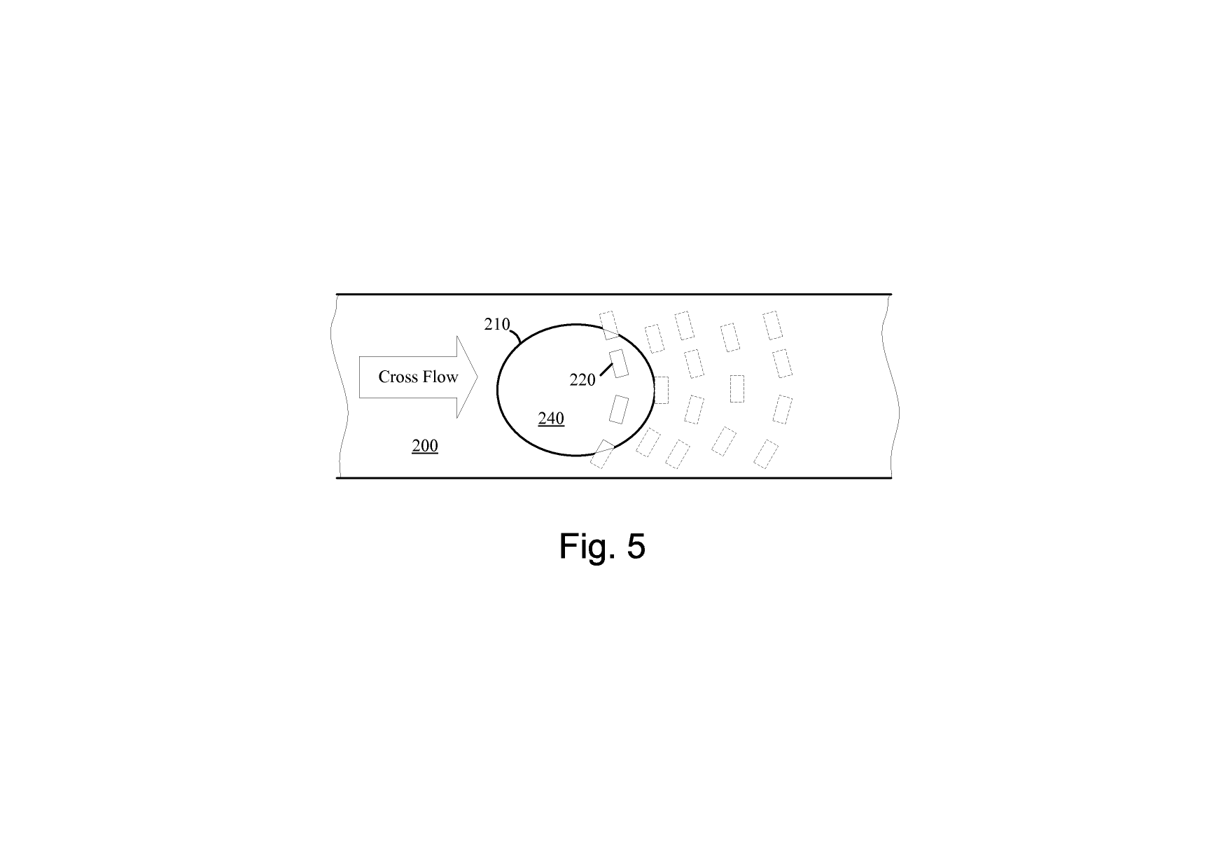

FIGS. 4 and 5 collectively show an impingement sleeve 200 with a hole 210 as is described herein and a turbulator(s) 220. For example, according to one embodiment, one or more holes 210 may be disposed through the impingement sleeve 200, and one or more turbulators 220 may be disposed within the airflow channel 230. The turbulators 220 may cause a vortex or turbulent flow within the otherwise laminar flow of the airflow channel 230. The turbulators 220 may provide greater uniformity of heat transfer between the combustion chamber 150 and the transition piece 165 and the cooling airflow within the airflow channel 230 by disrupting the laminar flow.

In certain embodiments, the turbulators 220 may include protuberances that extend from the liner 240 into the airflow channel 230. For example, in certain aspects, the turbulators 220 may be annular ribs that extend about the liner 240 and into the airflow channel 230. In other aspects, the turbulators may be disposed near or about the holes 210 in the impingement sleeve 200. Moreover, the turbulators 220 may include a variety of different shapes and sizes so as to increase heat transfer uniformity of the combustion chamber 150 and the transition piece 165. One will appreciate, however, that the turbulators 220 may be disposed at any location within the airflow channel 230 and may be any shape and/or size necessary so as to disrupt the laminar flow within the airflow channel 230 and increase heat transfer uniformity of the combustion chamber 150 and the transition piece 165.

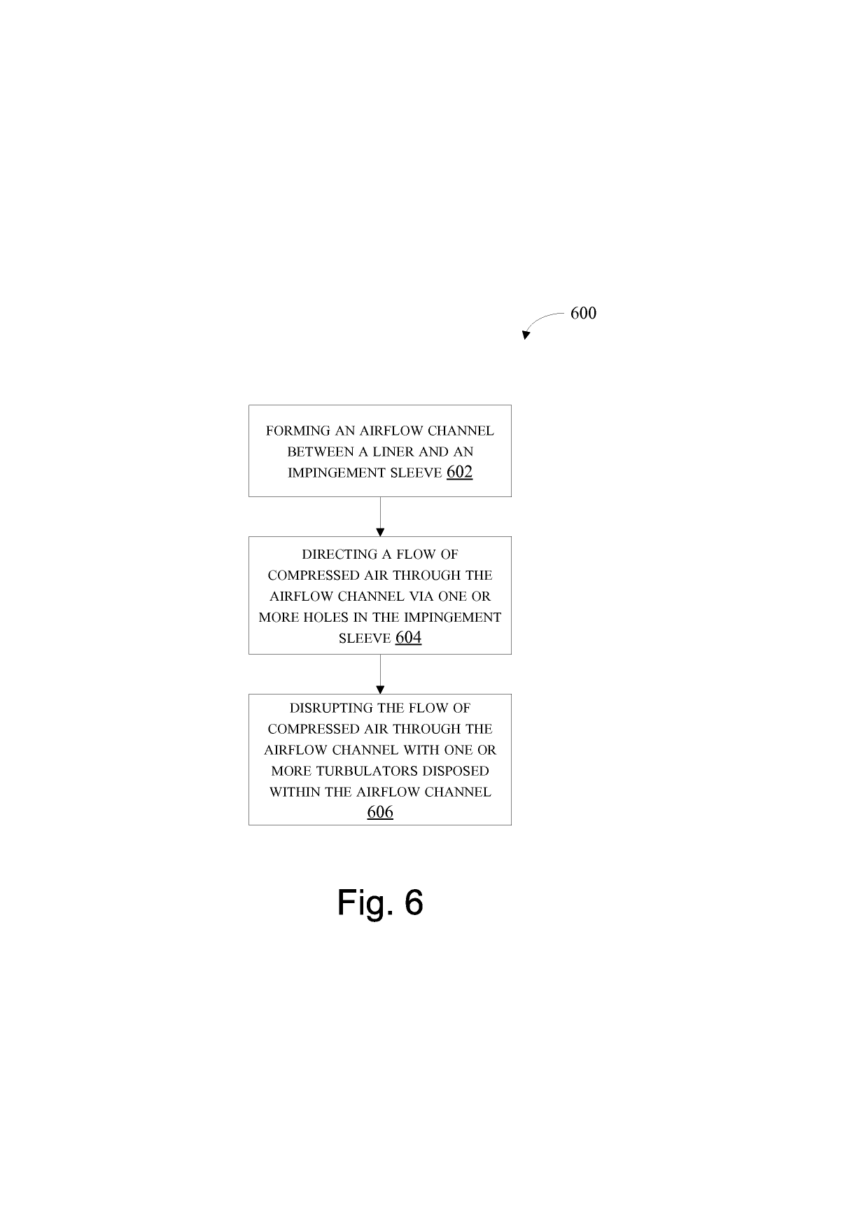

FIG. 6 illustrates an example flow diagram of a method 600 for increasing heat transfer within a transition piece of a combustor assembly. In this particular embodiment, the method 600 may begin at block 602 of FIG. 6 in which the method 600 may include forming an airflow channel between a liner and an impingement sleeve. At block 604, the method 600 may include directing a flow of compressed air through the airflow channel via one or more holes in the impingement sleeve. Moreover, at block 606, the method 600 may include disrupting the flow of compressed air through the airflow channel with one or more turbulators disposed within the airflow channel.

Although the disclosure has been illustrated and described in typical embodiments, it is not intended to be limited to the details shown, because various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

That which is claimed is:

1. A combustor assembly, comprising:
a liner;
an impingement sleeve disposed about the liner;
an airflow channel defined between the liner and the impingement sleeve;
one or more holes disposed through the impingement sleeve; and
one or more turbulators disposed within the airflow channel.

2. The combustor assembly of claim 1, wherein the liner and the impingement sleeve define a combustor transition piece.

3. The combustor assembly of claim 1, wherein the combustor assembly comprises a reverse flow combustor.

4. The combustor assembly of claim 1, wherein the liner defines a combustion chamber.

5. The combustor assembly of claim 1, wherein the one or more turbulators comprise a plurality of different shapes.

6. The combustor assembly of claim 1, wherein the one or more turbulators comprise a plurality of different sizes.

7. The combustor assembly of claim 1, wherein the one or more turbulators comprise protuberances extending from the liner into the airflow channel.

8. The combustor assembly of claim 1, wherein the airflow channel receives a flow of compressed air via the one or more holes disposed through the impingement sleeve.

9. The combustor assembly of claim 1, wherein the one or more turbulators increase uniformity of heat transfer within the combustor assembly.

10. The combustor assembly of claim 1, wherein the one or more turbulators are disposed about the one or more holes in the impingement sleeve.

11. A transition piece in a combustor assembly, comprising:
a liner;
an impingement sleeve disposed about the liner to form the transition piece;
an airflow channel defined between the liner and the impingement sleeve;
one or more holes disposed through the impingement sleeve; and
one or more tubulators disposed within the airflow channel.

12. The transition piece of claim 11, further comprising a reverse flow combustor.

13. The transition piece of claim 11, wherein the liner defines a combustion chamber.

14. The transition piece of claim 11, wherein the one or more tubulators comprise a plurality of different shapes.

15. The transition piece of claim 11, wherein the one or more tubulators comprise a plurality of different sizes.

16. The transition piece of claim 11, wherein the one or more tubulators comprise protuberances extending from the liner into the airflow channel.

17. The transition piece of claim 11, wherein the airflow channel receives a flow of compressed air via the one or more holes disposed through the impingement sleeve.

18. The transition piece of claim 11, wherein the one or more tubulators increase uniformity of heat transfer within the transition piece.

19. The transition piece of claim 11, wherein the one or more turbulators are disposed about the one or more holes in the impingement sleeve.

20. A method for increasing heat transfer within a transition piece of a combustor assembly, comprising:
forming an airflow channel between a liner and an impingement sleeve;
directing a flow of compressed air through the airflow channel via one or more holes in the impingement sleeve; and
disrupting the flow of compressed air through the airflow channel with one or more turbulators disposed within the airflow channel.
